(19) United States
(12) Patent Application Publication
(10) Pub. No.: US 2008/0221847 A1
(43) Pub. Date: Sep. 11, 2008

(54) METHOD OF DEVELOPING A PHARMACOKINETIC PROFILE OF A XENOBIOTIC DISPOSITION IN A MAMMALIAN TISSUE

(76) Inventor: Frederique Fenetteau, Montreal (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 12/044,745

(22) Filed: Mar. 7, 2008

Related U.S. Application Data
(60) Provisional application No. 60/894,176, filed on Mar. 9, 2007.

(51) Int. Cl. G06G 7/48

(52) U.S. Cl. 703/11

(57) ABSTRACT

There is provided a method of developing a pharmacokinetic profile of an xenobiotic disposition in a mammalian tissue, the method comprising inputting mammalian-specific data into a physiologically based pharmacokinetic (PBPK) model, where said mammalian-specific data comprises tansporter properties related data, where said transporter properties related data reflect genetic and environmental factors associated with said mammalian; inputting xenobiotic-specific data into said PBPK model; and simulating, using said PBPK model, a pharmacokinetic profile of said xenobiotic disposition as a function of said inputted data.

### FIELD OF THE INVENTION

The present invention relates generally to the field of pharmacy, pharmacokinetics, toxicology, health, laboratory medicine or clinic or medical practice and more particularly to a method of developing a pharmacokinetic profile of a xenobiotic disposition in a mammalian tissue.

### BACKGROUND OF THE INVENTION

As ideally, a same exposition to a xenobiotic should lead to an identical pharmacological or toxicological response for all people. However, many studies reveal that a same exposition to a xenobiotic does not systematically lead to same amount of this compound in blood. Furthermore, others studies show that people react differently to a same amount of this chemical substance in blood. One size fits all is in fact a great source of response variability.

These inter-individual differences in terms of amount of xenobiotic in blood and felt effects are partly explained by genetics and environmental factors which modulate the disposition of this chemical compound in the body. Genetic factors include gender or race, while environmental factors include age, polypharmacy, herbal medicines intake, and food intake, just to name a few. Besides, inappropriate exposition to xenobiotic as well as interactions between xenobiotic can lead to large amount of adverse events sometimes fatal.

As the toxicity and efficacy of a xenobiotic are mainly related to its concentration at the target tissue, any factor involved in the xenobiotic distribution in tissue is consequently involved in the effect of this xenobiotic. Whereas the lipophilicity of a xenobiotic has been mistakenly assumed to be the main predicting factor of xenobiotic distribution in tissue, other mechanisms have been recently found to have a significant function in xenobiotic distribution, like, but not limited to, the activity of membrane transporters. Some of these transporters have a protective function in tissue by contributing towards the excretion of the xenobiotic from tissue and are called efflux transporters. Some others contribute towards the entrance of xenobiotic in tissue and are called influx transporters.

As membrane transporters contribute to a selective distribution of xenobiotic to specific tissue, factors that modulate their activity or genetic expression may lead to a significant increase or decrease of xenobiotic concentration into target tissue, which translated into a change of the efficacy or toxicity of the chemical substance.

For example, many cases of cardiotoxicity and tachycardia have been associated to high intravenous doses of domperidone, an antiemetic drug. This drug is a substrate of the well-known membrane transporters, P-glycoprotein (P-gp) expressed in heart but also in intestine, kidneys, liver, and brain. Its principal function is to transport its substrates out of the tissue against a concentration gradient and then, limit xenobiotic penetration into target tissues.

The genetic expression and the activity of transporters can be modulated by the simultaneous presence of other xenobiotic. Then, interactions altering the P-gp activity/expression may lead to increased cardiac tissue concentrations of domperidone, thereby raising the risk of cardiac arrest. It also exist inter-individual differences in the genetic expression of transporters: some individuals express a high amount of transporters whereas others express a small amount.

To prevent such adverse events and optimize xenobiotic exposition, it is then important to be able to predict xenobiotic disposition under various conditions of exposition. Hence, the principal xenobiotic disposition processes, called pharmacokinetics (PK), need to be fully characterized. PK modeling has been developed to allow understanding xenobiotic disposition.

Main conventional pharmacokinetics models developed so far are classical compartmental models and physiologically-based pharmacokinetics (PBPK) models. These models are principally distinguished by their structure and their capacity of extrapolations and predictions of xenobiotic disposition.

On the one hand, conventional compartmental models, of which the structure entirely depends on best fit of experimental data, are limited in terms of inter-doses and interspecies extrapolations as well as in terms of prediction of xenobiotic concentration in each tissue of the body.

On the other hand, the structure of conventional PBPK models is composed of compartments that represent tissues and organs connected via the vascular system and mimic the anatomical structure of the mammal being studied. These models are powerful in terms of prediction of xenobiotic concentration in tissues and in terms dose and interspecies extrapolation.

However, conventional PBPK models have not been designed to characterize distribution of xenobiotic in tissues under conditions of modulation of main factors influencing their body disposition, such as metabolism enzymes or membrane transporters: more specifically, these models do not take into account efflux or influx mechanisms of membrane transporters, which respectively contribute towards the decrease or increase of xenobiotic concentration in target tissue.

Although there are various conventional PBPK models tailored to understand xenobiotic disposition, none of these methods adequately deal with the issues discusses above.

### SUMMARY OF THE INVENTION

It is therefore an object of the present invention to provide a method that overcomes the above-mentioned drawbacks.

As a first aspect of the invention, there is provided a method of developing a pharmacokinetic profile of an xenobiotic disposition in a mammalian tissue, the method comprising:
inputting mammalian-specific data into a physiologically based pharmacokinetic (PBPK) model, where the mammalian-specific data comprises transporters properties related data, where the transporters properties related data reflect genetic and environmental factors associated with the mammalian;
inputting xenobiotic-specific data into the PBPK model; and
simulating, using the PBPK model, a pharmacokinetic profile of the xenobiotic disposition as a function of the inputted data.

Preferably, the transporter properties related data comprises an in vivo estimated diffusion value and at least one of an in vivo estimated efflux value and an in vivo estimated influx value of the xenobiotic through the mammalian tissue.

Preferably, the estimated in vivo diffusion value of the xenobiotic through the mammalian tissue is carried out by:
estimating an in vitro diffusion value of the xenobiotic through a membrane of the mammalian; and
using the estimated in vitro diffusion value for estimating the in vivo diffusion value of the xenobiotic through the mammalian tissue.

The method preferably further comprises estimating a correlation value between in vitro and in vivo diffusion of the xenobiotic through the membrane, wherein the using the estimated in vitro diffusion value for estimating the in vivo diffusion value is carried out by extrapolating the estimated in vitro diffusion value using the correlation value.

The mammalian tissue is preferably selected from the group consisting of a heart, a brain, a liver, kidneys and intestine.

The xenobiotic is preferably selected from the group consisting of a drug, an herbal medicine, a chemical organic pollutant, a chemical inorganic pollutant and a cosmetic product.

The mammalian consists of any laboratory animal or human.

The mammalian-specific data preferably further comprises physiological and anatomical properties of the mammalian related data.

The physiological and anatomical properties of the mammalian related data are preferably selected from the group consisting of volume of tissues, composition of the tissues in lipid, phospholipids and water, volume of blood in equilibrium in the tissues and blood flow to the tissues.

The xenobiotic-specific data preferably comprises physiochemical properties of the xenobiotic related data.

The physiochemical properties of the xenobiotic related data are preferably selected from the group consisting of molecular weight, lipophilicity and solubility of the xenobiotic.

Preferably, the process of estimating an in vitro diffusion value of the xenobiotic through a membrane of the mammalian comprises:
determining a permeability value of the xenobiotic through the membrane from apical to basolateral side;
determining a permeability value of the xenobiotic through the membrane from basolateral to apical side; and
estimating the in vitro diffusion value using the determined permeability values.

The process of estimating an in vitro diffusion value is preferably carried out by using a mathematical equation comprising as parameters the measured permeability values.

The estimation of the at least one of an in vivo estimated efflux value and an in vivo estimated influx value of the xenobiotic through the mammalian tissue is preferably obtained by:
determining a permeability value of the xenobiotic through the membrane from apical to basolateral side;
determining a permeability value of the xenobiotic through the membrane from basolateral to apical side; and
estimating the at least one of an in vivo efflux value and an in vivo influx value of the xenobiotic using the determined permeability values.

The process of estimating the at least one of an in vivo efflux value and an in vivo influx value of the xenobiotic is preferably carried out by using a mathematical equation comprising as parameters the measured permeability values.

Preferably, the process of estimating a correlation value between in vitro and in vivo diffusion of the xenobiotic through the membrane comprises:
estimating a correlation value between in vitro and in vivo diffusion of various transporters substrates; and
estimating the correlation value between in vitro and in vivo diffusion of the xenobiotic through the membrane using the estimated correlation value between in vitro and in vivo diffusion of various transporters substrates.

The estimations of the correlation values are preferably carried out by using mathematical equations.

The simulated pharmacokinetic profile of the xenobiotic disposition can comprise a predicted distribution profile of the xenobiotic in the mammalian tissue.

The simulated pharmacokinetic profile of the xenobiotic disposition can also comprise a predicted amount and rate of absorption of the xenobiotic in the mammalian tissue.

The simulated pharmacokinetic profile of the xenobiotic disposition can also comprise a predicted concentration-time profile of the xenobiotic in the mammalian tissue.

The simulated pharmacokinetic profile of the xenobiotic disposition can also comprise an eliminated amount of the xenobiotic by hepatic metabolism and by renal or fecal excretion.

### BRIEF DESCRIPTION OF THE DRAWINGS

Further features and advantages of the present invention will become apparent from the following detailed description, taken in combination with the appended drawings, in which:

FIG. 1 is a diagram illustrating the various input parameters of the PBPK model, the output parameters thereof and the benefits achieved;

FIG. 2 is a diagram illustrating the PBPK framework;

FIG. 3A is a diagram illustrating a tissue distribution model applied to liver and kidneys according to a first embodiment of this invention;

FIG. 3B is a diagram illustrating a tissue distribution model applied to brain and heart according to a second embodiment of the present invention;

FIG. 4 is a flow chart illustrating the process of estimating values of drug diffusion rate and drug efflux rate according to another embodiment of the present invention;

FIG. 5 is a diagram showing drug diffusion and efflux processes from apical to basolateral side and conversely through the cell membrane;

FIG. 6 is a histogram showing an example of prediction results obtained according to a first embodiment of the present invention; and

FIG. 7 is a flow chart illustrating a method of developing a pharmacokinetic profile of a xenobiotic disposition in a mammalian tissue.

### DETAILED DESCRIPTION OF THE INVENTION

The invention presents a computer-implemented method, based on a new PBPK modeling approach, for predicting and understanding xenobiotic disposition in a mammalian body in function of various genetic and environmental factors.

This new PBPK modeling approach takes into account the genetic expression and activity of influx/efflux transporters in mammalian tissues and predicts xenobiotic distribution in these tissues under various conditions of these transporters.

Target tissues include brain, liver, heart, kidneys, gut, muscles, skin, adipose, spleen, lung, stomach, placenta, testes, ovaries, etc.

Development of tissue models and mass balance systems around each tissue lead to a system of ordinary differential equations (ODE) representing the whole-body PBPK model. This system of equations is solved using a computer-implemented method.

The prediction of xenobiotic disposition in the mammalian body using this computer-implemented method requires parameters related to mammalian physiology and anatomy, physicochemical properties of the xenobiotic, genetic and environmental factors affecting xenobiotic disposition in a body, such as race, gender, food, or multi-exposition to xenobiotic, to name a few.

The outputs of the computer-implemented method are the xenobiotic distribution into each tissue, its metabolism, and its excretion from the body. More precisely, the software results are concentration-time profiles of xenobiotic in each tissue, the eliminated amount by hepatic metabolism and by renal or fecal excretion. These results are obtained by considering a specific exposition to the xenobiotic, such as the dose, the intrinsic properties of the mammalian such as pathological states, genetic or age factors.

An important benefit of the present invention is that it provides understanding and predicting the mechanisms of xenobiotic disposition in tissues and organs under various genetic and environmental factors.

Another important benefit of the present invention is that it allows the identification of main factors involved in tissue distribution of the xenobiotic under study. Furthermore, the present computer based method also allows the quantification of the contribution of each factor involved in the xenobiotic distribution and ranks their implication.

Another benefit of this invention is that it provides a method that optimizes the xenobiotic exposition and its use by taking into account various genetic and environmental factors that may affect its exposition.

Another benefit of the present invention is that it allows the prevention of adverse events related to the xenobiotic exposition and consequently, it allows the decrease of health costs (hospitalization, doctor consultations, etc) related to a bad use of xenobiotic which can be sometimes fatal, such as torsades de pointes, coma, cardiac arrest, etc.

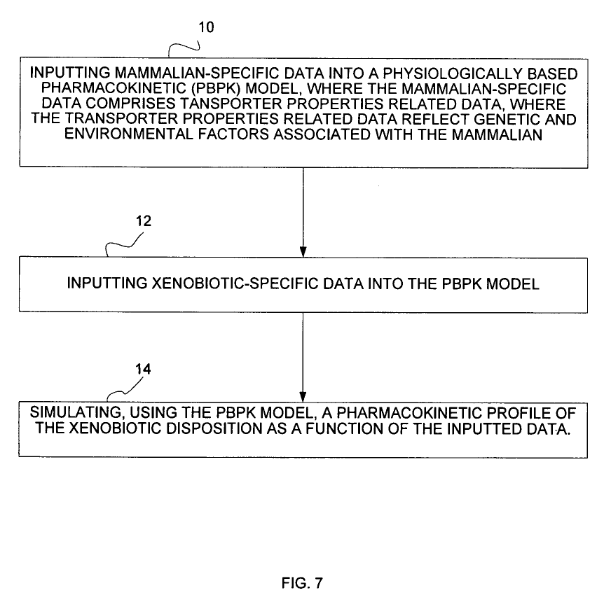

As illustrated in FIG. 7, as a first aspect of the invention, there is provided a method of developing a pharmacokinetic profile of an xenobiotic disposition in a mammalian tissue, the method comprising:
inputting mammalian-specific data into a physiologically based pharmacokinetic (PBPK) model, where the mammalian-specific data comprises tansporter properties related data, where the transporter properties related data reflect genetic and environmental factors associated with the mammalian 10;
inputting xenobiotic-specific data into the PBPK model 12; and
simulating, using the PBPK model, a pharmacokinetic profile of the xenobiotic disposition as a function of the inputted data 14.

To facilitate the understanding of the invention, the description of the preferred embodiment is arranged within the following sections: (1) General Structure, (2) Parameters Determination, and (3) Results and Applications, (4) Glossary of Terms and Acronyms.

Section 1: General Structure

Disclosed is software, based on new PBPK modeling approach, which enables to understand and predict xenobiotic disposition in a mammalian body by taking into account various genetic and environmental factors that may affect its effect.

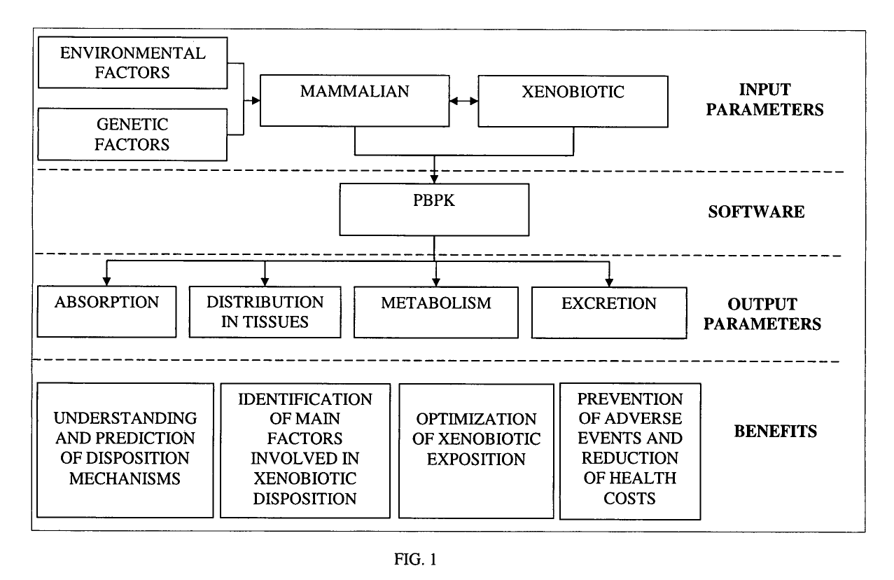

FIG. 1 illustrates the various input parameters of the PBPK model, the output parameters thereof and the benefits achieved. The input parameters are related to the mammalian body and the xenobiotic under study. The input parameters are transmitted to the PBPK software that simulates a pharmacokinetic profile of the xenobiotic and outputs various output parameters. The xenobiotic may be any type of foreign body substance such as drug, herbal medicine, chemical/organic/inorganic pollutant, or cosmetic product. The mammalian may be any laboratory animal or human. Physicochemical properties of the xenobiotic, and the mammalian anatomy and physiology, are used as input parameters of the software. Physicochemical properties of the xenobiotic include, but are not limited to, its molecular weight, its lipophilicity, or its solubility. Physiological data include, but are not limited to, the volume of tissues (Vₜ), their composition in lipids and water, the volume of blood in equilibrium in tissues (Vb_{l,t}), and the blood flow to tissues (Qₜ). Some input data are also related to both xenobiotic properties and mammalian physiology, such as the expression of proteins or enzymes involved in distribution or elimination mechanisms in specific organs (CL), and for which the xenobiotic has an affinity, such as cytochromes P450 (CL_{P450}) and P-glycoproteins (CL_{Pgp}) just to name a few. In addition, the system includes, but is not limited to, genetic and environmental factors that modulate some specific physiological properties of the mammalian body. This (or these) modulation(s) affect(s) the xenobiotic disposition and consequently its effect on the body. The genetic factors include, but are not limited to, gender, race, age or ethnicity. The environmental factors include, but are not limited to, food, polypharmacy, disease or mammalian environment.

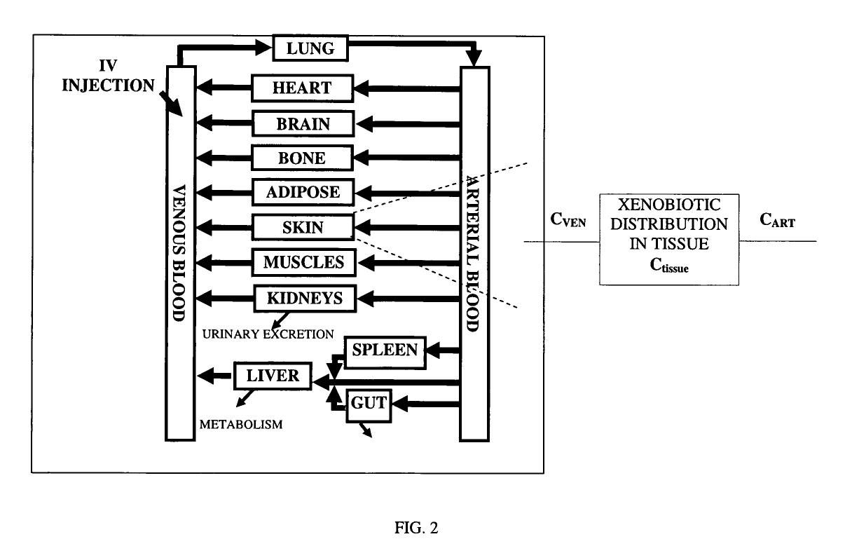

FIG. 2 illustrates a PBPK model framework. In one embodiment, when the xenobiotic is administered intravenously to a mammalian, the injected xenobiotic passes through lungs and reaches the arterial circulation from where it distributes in tissues and organs. Other routes for the xenobiotic to reach the venous blood circulation include oral, inhalation, cutaneous, intramuscular, or rectal administration/penetration. With reference to FIG. 2, independently of the administration route, the xenobiotic is eliminated by the liver and transformed in metabolites. The chemical substance can also be eliminated unchanged by renal and fecal excretion.

In this new PBPK modeling approach, muscles, bone, adipose, skin, spleen, are represented by a perfusion rate limited model, also known as well-stirred model. Other tissue model can be used for these tissues. In the case of a well-stirred model, the mass balance around such a tissue is represented by the Equation 1, where Cₜ is the concentration in tissue, Qt the blood flow to tissue, Vₜ the volume of tissue, Cₐᵣₜ the arterial blood concentration, and Cᵥₜ, the venous blood living tissue concentration:

$$\frac{d Ct}{d t} = \frac{{Q}_{t}}{{V}_{t}} \cdot ( {C}_{art} - {C}_{v , t} ) \qquad Equation 1$$

Arterial blood and venous blood are also represented by a well stirred model with the following mass-balance equations. Equation 2 refers to arterial blood mass balance, while equation 3 refers to venous blood mass balance.

$$\begin{matrix}\frac{d {C}_{art}}{d t} = \frac{{Q}_{c}}{{V}_{ab}} ( {C}_{v , l} - {C}_{art} ) & Equation 2 \\ \frac{d {C}_{vb}}{d t} = \frac{1}{{V}_{vb}} \sum ( {Q}_{t} \cdot {C}_{v , t} - {Q}_{c} \cdot {C}_{vb} + Input ) & Equation 3\end{matrix}$$

On the other hand, heart and brain tissues are represented by a permeability rate model. Particular to the present invention, the rate limitation property at the capillary membrane is attributed to, but not limited to, the diffusion rate of the xenobiotic and the influx/efflux activity of membrane transporters.

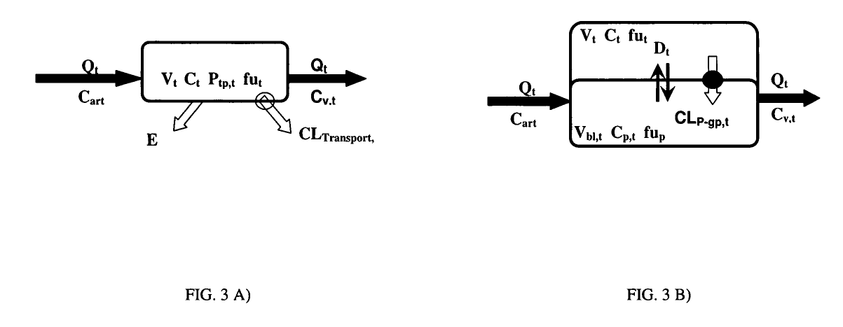

In one embodiment, with reference to FIG. 3B, the distribution of a xenobiotic is described herein as the summation of the diffusion rate (Dₜ) of the xenobiotic between the circulating blood and tissue, and the transport mechanism of the xenobiotic by efflux transporters (P-gp) expressed at the membrane separating circulating blood from the tissue, called clearance due to the transporters activity (CL_{P-gp,t}). In reference to FIG. 3B, the mass balance equation is built in two steps because two sub-compartments are considered; the tissue (extravascular compartment) represented by Equation 4, and the blood in equilibrium with tissue (vascular compartment) represented by Equation 5:

$$\frac{d {C}_{t}}{d t} = \frac{1}{{V}_{t}} \cdot [ {D}_{t} \cdot ( {fu}_{p} \cdot {C}_{p , t} - {fu}_{t} \cdot {C}_{t} ) - {CL}_{Pgp , t} \cdot {fu}_{t} \cdot {C}_{t} ] \qquad Equation 4$$

Referring to Equation 4, fᵤₚ is the unbound fraction of xenobiotic in plasma, fᵤₜ is the unbound fraction of xenobiotic in tissue, Ct is the concentration in tissue, C_{p,t} is the concentration in plasma, Dₜ is the diffusion rate through tissue membrane, and CL_{P-gp,t} is the efflux clearance of the xenobiotic due to P-gp activity.

$$\frac{d {C}_{v , t}}{d t} = \frac{1}{{V}_{bl , t}} \cdot [ {Q}_{t} \cdot ( {C}_{art} - {C}_{v , t} ) + {D}_{t} \cdot ( {fu}_{t} \cdot {C}_{t} - {fu}_{p} \cdot {C}_{p , t} ) + {CL}_{Pgp , t} \cdot {fu}_{t} \cdot {C}_{t} ] \qquad Equation 5$$

Referring to Equation 5, C_{v,t} is the concentration of xenobiotic in blood in equilibrium with tissue and V_{bl,t} is the volume of blood in equilibrium with tissue.

Finally, liver and kidneys are represented by a modified version of the well-stirred model. Particular to the present invention, drug distribution in these tissues is represented by a WS model in which the excretive function of P-gp is represented by an efflux clearance, CL_{P-gp,t}, from a perfectly mixed tissue, as illustrated in FIG. 3A. In liver, an additional mechanism of metabolism is taken into account and represented by the hepatic extraction ratio E. In reference to FIG. 3A, the masse balance equation around the tissue (Liver or Kidney) is presented as follows:

$$\frac{d {C}_{t}}{d t} = \frac{{Q}_{t}}{{V}_{t}} \cdot [ {C}_{art} - {C}_{v , t} - {fu}_{t} \cdot {CL}_{p - gp , t} \cdot {C}_{t} - E \cdot ( {C}_{art} - {C}_{V} ) ] \qquad Equation 6$$

Referring to Equation 6, fᵤₜ is the unbound fraction of xenobiotic in tissue, CI_{P-gp, t} is the efflux clearance due to P-gp activity in the tissue, and E is the hepatic extraction ratio only considered in liver mass balance.

The whole-PBPK model is then mathematically formulated as a set of ordinary differential equations (ODE) of mass balance that represents the time dependent variation of the drug concentration in each tissue, represented either by a perfusion rate limited model, or more advanced models as presented in FIG. 3A and FIG. 3B. Then, if N tissues are included in the PBPK model, the whole system will be formulated by at least N ODE. The complexity of the mass balance equation increases with the complexity of distribution model associated to the tissue distribution of the xenobiotic under study. This ODE system is solved with a text-based programming software able to handle large linear systems of ordinary differential equations, such as Matlab®. Other mathematical language can be used.

In the embodiment of the prediction of domperidone distribution in brain, heart, liver and kidneys, the development of tissue models that include values of the drug diffusion rate through tissue membrane Dₜ and genetic expression and activity of P-gp, CL_{P-gp,t}, prior to any in vivo experiments, is the ingenuosity of the present invention. This is done by performing extrapolations from in vitro measurements as described in the next section.

In the same embodiment, results of the computer-based model are presented as the concentration-time profiles of drug in each tissue considered in the model as well as the time-profile of eliminated amount of drug by metabolism and renal excretion, in presence or absence of P-gp activity.

Section 2: Parameters Determination

Most of the parameters related to the physicochemical properties of the drug as well as the main parameters related to the physiology of the mammalian, such as body weight, volume and composition of tissues, blood flow to tissues, are easily found in the scientific literature. However, in the particular embodiment of prediction of domperidone disposition in mice body, the main challenge is to estimate the value of diffusion (Dₜ) and transporter efflux (CL_{Transport,t}) rates of the drug through the tissue capillary membrane prior to in vivo experiments. In other words, the main challenge is to estimate the value of genetic and physiologic factors involved in drug disposition. Indeed, efflux rate due to the transporter activity takes into account the genetic expression of this transporter in various mammalian tissues, its activity and the affinity of the xenobiotic to this transporter.

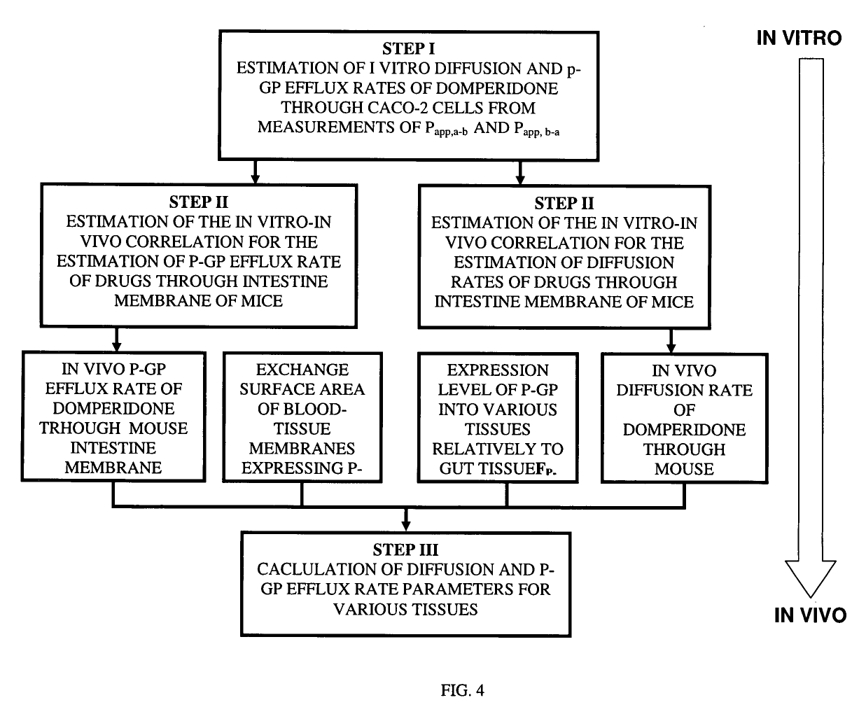

In the case of prediction of domperidone disposition in mouse tissues, the determination of domperidone diffusion rate and P-gp efflux rate in brain, heart, liver, and kidneys is performed through the following three-step procedure presented in FIG. 4. This procedure use in vitro measurements of apparent permeability of domperidone through a cell membrane (like Caco-2 monolayers) expressing P-gp, in order to obtain in vivo values of diffusion and efflux rates of domperidone through mouse tissue membranes. This procedure is performed using extrapolations method. The three-step procedure is described below in the embodiment of estimation of domperidone diffusion and P-gp efflux rates through tissue membrane of mouse brain, heart, liver and kidneys.

Step I: Estimation of In Vitro Diffusion and P-gp Efflux Rates of Domperidone Through Cell Membrane Expressing P-gp (Caco-2 Monolayers):

The first step is to determine, in vitro, the value of drug diffusion rate and P-gp efflux rate of the drug through a membrane which expresses transporters genes.

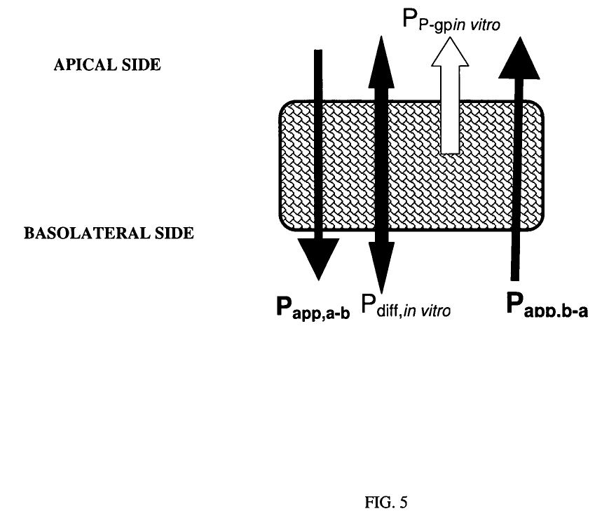

As illustrated in FIG. 5, P-gp genes are expressed at the apical side of the membrane, leading to an efflux from the basolateral to the apical side. The apparent permeability of the drug through the membrane is measured in both directions, from apical to basolateral (P_{app,a-b}), and from basolateral to apical (P_{app,b-a}). P_{app,a-b} of drugs through monolayers results from the difference between drug diffusion rate (P_{diff,in-vitro}) and P-gp efflux rate (P_{P-gp,in-vitro}). Basolateral to apical apparent permeability (P_{app,b-a}) is the result of the additive action of the drug diffusion along with P-gp efflux transport. Once P_{app,a-b} and P_{app, b-a} are measured, the estimation of in vitro domperidone diffusion and P-gp efflux rates (P_{diff,in-vitro} and P_{P-gp,in-vitro}) are calculated as follows:

$$\begin{matrix}{P}_{diff , in \text{-} vitro} = \frac{1}{2} \cdot ( {P}_{app , b - a} + {P}_{app , a - b} ) & Equation 7 \\ {P}_{Pgp , in \text{-} vitro} = \frac{1}{2} \cdot ( {P}_{app , b - a} - {P}_{app , a - b} ) . & Equation 8\end{matrix}$$

Domperidone P_{app,b-a} and P_{app,a-b} values are generally published in the scientist literature, but can also be measured directly by performing apparent permeability measurements through monolayers like Caco-2.

Step II: In Vitro-In Vivo Extrapolation of Drug Diffusion Rate and P-gp Efflux Rate Parameters:

This second step consists in the development of regressions that allows the extrapolation of in vitro values of diffusion and efflux rates of various P-gp substrates to the in vivo situation. Values of P_{app,b-a} and P_{app,a-b} as well as the ratio of P_{app,a-b} in the presence and absence of a P-gp inhibitor for various P-gp substrates through Caco-2 monolayers are collected in the scientific literature. The value of the maximal efflux velocity of P-gp (Vₘₐₓ) and the value of the affinity of drug for P-gp (Kₘ) are also measured for different P-gp substrates. Then, comparisons of concentration-time profiles in plasma after oral administration of these compounds are performed on normal mice expressing P-gp (called wild type WT) and on P-gp genetically deficient mice (called knock-out KO). This comparison is performed by using the ratio of plasma area under the curve (AUC) between both species (R_{AUC}). RAUC is expressed as

$${R}_{AUC} \approx \frac{{P}_{diff , in \text{-} vivo}}{{P}_{diff , in \text{-} vivo} - {P}_{Pgp , in \text{-} vivo}} . \qquad Equation 9$$

From Step I, in vitro values of P_{app,a-b} and P_{app,b-a} are used to estimate P_{diff,in-vitro} and P_{P-gp,in-vitro} for each P-gp substrate. Then, the value of in vivo diffusion rate of these P-gp substrates through membrane from R_{AUC} value are approximated as follows:

$$\begin{matrix}\begin{matrix}{P}_{diff , in \text{-} vivo} \approx \frac{{R}_{AUC}}{{R}_{AUC} - 1} \cdot {P}_{Pgp , in \text{-} vivo} \\ ≅ \frac{{R}_{AUC}}{{R}_{AUC} - 1} \cdot \frac{{V}_{max ( P \text{-} gp )}}{{K}_{m ( P \text{-} gp )}} .\end{matrix} & Equation 10\end{matrix}$$

Then, the correlation between in vitro and in vivo drug diffusion rates and the correlation between in vivo and in vitro efflux rates due to P-gp activity are assessed with statistical software, like S-Plus®. Then, the in vivo/in vitro correlation in term of P-gp efflux rate is found to be:

(Vₘₐₓ/Kₘ)in vivo=4.75×P_{Pgp,in-vitro} (R²=0.920)

And, the in vivo-in vitro correlation in term of diffusion rate of drug through gut membrane is found to be:

P_{diff,in vivo}=4.66×P_{diff,in-vitro} (R²=0.9134)

Finally, these correlations are used to estimate the value of in vivo diffusion and efflux rates of domperidone from P_{P-gp,in-vitro} and P_{diff,in-vitro} parameters calculated in Step I.

Step III: Calculation of the Diffusion Rate and P-gp Efflux Clearance of Domperidone into Brain, Liver, Kidneys and Heart:

The efflux clearance induced by P-gp activity is tissue-dependent. Thus, P-gp expression levels in various tissues of WT mice are used to account for this tissue specificity. Since the Caco-2 cells line derives from human colon carcinoma and its characteristics are similar to intestinal epithelial cells, the intestinal tissue is chosen as the reference tissue for P-gp expression level. The P-gp expression level in each of the other tissues is estimated as a fraction of intestine P-gp expression (F_{P-gp,t}) which is used as a correcting factor of the P-gp efflux clearance in the tissue. The ingenuosity of this step is that the diffusion rate, expression and amount of P-gp are assumed to be proportional to the exchange surface area of the capillary membrane Sₜ. The following equations are used to estimate CL_{P-gp,t,} and Dₜ (L/min):

$$\begin{matrix}{CL}_{Pgp , t} = \frac{{V}_{max ( P \text{-} gp )}}{{K}_{m ( P \text{-} gp )}} \cdot {S}_{t} \cdot {F}_{Pgp , t} & Equation 11 \\ {D}_{t} = {P}_{diff , in \text{-} vivo} \cdot {S}_{t} . & Equation 12\end{matrix}$$

This three-step procedure allows the determination of the value of domperidone diffusion and efflux rates in heart, brain, liver and kidneys. Theses values are used as input parameters of the software. This allows the prediction of domperidone distribution in various mice tissues expressing P-g, prior to any in vivo measurements. This method is a true predictive method. This procedure can obviously be used for other xenobiotic, transporters, mammalian, and tissues, and should not to limit the scope of the invention. Accordingly, the scope of the invention should be also defined in accordance with the claims (not included).

Section 3: Results and Applications

The outputs of the present invention are the amount and rate of xenobiotic absorbed, concentration-time profiles of xenobiotic in each tissue, eliminated amount by hepatic metabolism and by renal or fecal excretion. These outputs are obtained by considering a specific exposition to the xenobiotic, such as the dose, the intrinsic properties of the mammalian, its genetic, its pathological state, etc.

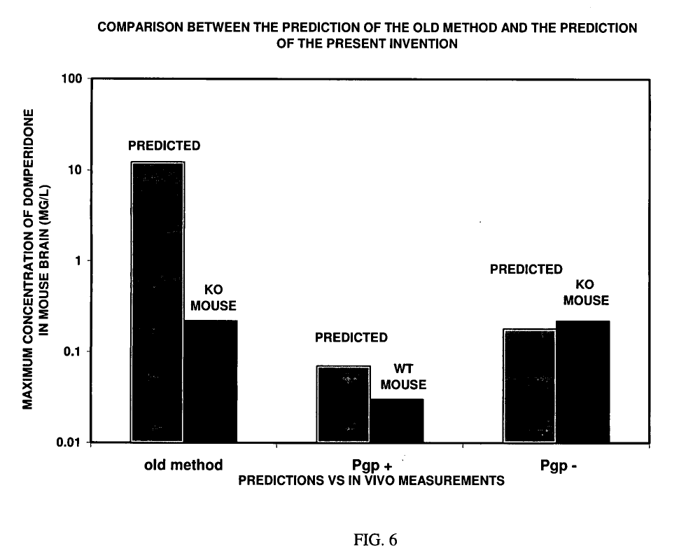

The interpretation of these results allows the understanding and the prediction of the mechanisms of xenobiotic disposition in tissues and organs under various genetic and environmental factors. In one embodiment, domperidone concentration in mouse brain was successfully predicted by the present invention in presence or in absence of P-gp activity at the blood-brain barrier as illustrated in FIG. 6.

The interpretation of these results allows the identification of main factors involved in tissue distribution of the xenobiotic under study. For example, if this chemical substance is a substrate of membrane transporters and is lipohilic enough to diffuse through the tissue membrane, the present invention can identify which one of the processes has a more significant function in the tissue distribution. In the previous embodiment, the present invention allows the identification of the P-gp efflux transport as the main factor influencing domperidone distribution in mouse brain. Furthermore, if the present method identifies the membrane transporters as the main actors of this xenobiotic distribution, and that the expression/activity of this transporter depends on the race, gender, or can be modulated by the presence of other xenobiotic, the software will also identify these environmental and genetic factors as potentially involved in the tissue distribution of this chemical substance. The present computer based method also allows the quantification of the contribution of each factor involved in the xenobiotic distribution and ranks their implication.

Additionally, the present invention allows the identification of the possible involvement of additional mechanisms in the xenobiotic disposition and it allows the suggestion to perform additional experiments in order to identify the exact nature of these mechanisms. In one embodiment, the present invention elucidates the mechanism of domperidone distribution by highlighting the significant distribution function of P-gp as well as additional transporters into brain and cardiac tissues. The exact nature of these additional transporters is unknown, but the model was able to quantify their implication and activity in drug distribution into these tissues. The model identified a significant involvement of an influx process at the cardiac epithelium as well as an efflux process at the blood brain barrier, in the domperidone distribution. Additional experiments are suggested by the software in order to identify this (these) transporters or enzyme(s).

The interpretation of these results allows the optimization of the xenobiotic exposition and its use by taking into account various genetic and environmental factors that may affect its exposition. Indeed this method allows the decrease of the xenobiotic toxicity related to its inappropriate use. It also allows the improvement of the xenobiotic efficacy throughout its optimized use. In one embodiment, the present invention provides the posology adaptation for patients with multi-medications associated to their diseases. These multi-medications lead to higher risks of adverse drugs reactions due to drug-drug interactions. These interactions modulate drugs concentrations in tissues and consequently the efficiency and toxicity of the drugs. Then the recommended posology will not be the same if a drug X is administered to a 20-year-old Black woman with no other disease than if it is administered to a 65-year-old Caucasian man suffering of hepatic and renal insufficiencies. In alternative embodiment, the present invention can be a very useful tool for CRO companies which perform preclinical studies and toxicological studies on laboratories animal to investigate the efficiency and toxicity of a new drug candidate, or a xenobiotic.

In a particular embodiment, the present invention also provides to suggest an update of the drug formulation to pharmaceutics depending on the prediction of drug distribution for a sub-group of population. For example if the software identifies a particular disease or ethnicity as a factor that significantly affects the drug distribution (and thus its efficiency and toxicity). Thus, if this modulation of drug efficiency can be attenuated by a modification of the drug formulation, the software will suggest an update of the pharmaceutical formulation as well as an update of the fabrication process of the drug.

Furthermore, the present invention allows the acceptation of a new drug candidate for a sub-population which would have been rejected somehow (otherwise). Indeed, the usual interpretation of a clinical trial comparing two interventions in a population assumes that if a superior intervention is found, it will be the best choice for any given individual in that population. In fact, a treatment with 10% advantage over a comparator could still be the wrong drug for many people, and a drug with severe side effect may be the best treatment for people who are not at risk for that problem. The present invention allows the administration of a treatment to the appropriate sub-population and the limitation of the severe side effects.

Section 4: Glossary of Terms and Acronyms

| | | |
|---|---|---|
| AUC | Area under the curve | mg/L/min |
| C | Drug concentration | mg/L |
| Cₗₐₛₜ | Concentration measured at the last sampling point | mg/L |
| Cl_{P-gp,t} | P-gp efflux clearance from a tissue | L/min |
| Cₘₐₓ | Maximum concentration in tissue or plasma | mg/L |
| Dₜ | Drug Diffusion rate through tissue membrane | L/min |
| E | Hepatic extraction coefficient | |
| F_{P-gp,t} | Fraction of expression level of P-gp in a tissue | |
| fuₚ | Unbound fraction of drug into plasma | |
| fuₜ | Unbound fraction of drug into tissue | |
| Kₘ | Affinity constant for P-gp | μM |
| KO mice | Knockout mice | |
| ODE | Ordinary Differential Equations | |
| P_{app,a-b} | Apical to basolateral apparent permeability | dm/min |
| | through the Caco-2 monolayer | |
| P_{app,b-a} | Basolateral to apical apparent permeability | dm/min |
| | through the Caco-2 monolayer | |
| PBPK | Physiologically Based Pharmacokinetic | |
| P_{diff,in vitro} | In vitro diffusion rate of the drug through the | dm/min |
| | Caco-2 monolayer | |
| P_{diff,in vivo} | In vivo diffusion rate of the drug through a | dm/min |
| | capillary membrane | |
| P-gp | P-glycoprotein | |
| P_{P-gp,in vitro} | in vitro P-gp efflux rate | dm/min |
| P_{P-gp,in vivo} | in vivo P-gp efflux rate | dm/min |
| P_{tp,t} | Partition coefficient of drug into tissue | |
| Qₜ | Blood flow to tissue | L/min |
| R_{AUC} | Ratio of plasma AUC measurements between WT and | |
| | KO mice | |
| Sₜ | Exchange surface area separating vascular | dm² |
| | space from extravascular space | |
| V_{bl,t} | Volume of blood in equilibrium with tissue | L |
| V_{max(P450)} | Maximum velocity of CYP450 | nmol/nmolP450/min |
| | (Michaelis-Menten kinetic parameter) | |
| V_{max (P-gp)} | Maximum velocity of P-gp efflux rate | nmol/hr/cm² |
| Vₜ | Volume of a tissue | L |
| WS model | Well-stirred model | |
| WT mice | Wild Type mice | |

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1. A method of developing a pharmacokinetic profile of an xenobiotic disposition in a mammalian tissue, the method comprising:
inputting mammalian-specific data into a physiologically based pharmacokinetic (PBPK) model, where said mammalian-specific data comprises tansporter properties related data, where said transporter properties related data reflect genetic and environmental factors associated with said mammalian;
inputting xenobiotic-specific data into said PBPK model; and
simulating, using said PBPK model, a pharmacokinetic profile of said xenobiotic disposition as a function of said inputted data.

2. The method as claimed in claim 1, wherein said transporters properties related data comprises an in vivo estimated diffusion value and at least one of an in vivo estimated efflux value and an in vivo estimated influx value of said xenobiotic through said mammalian tissue.

3. The method as claimed in claim 2, wherein said estimated in vivo diffusion value of said xenobiotic through said mammalian tissue is carried out by:
estimating an in vitro diffusion value of said xenobiotic through a membrane of said mammalian; and
using said estimated in vitro diffusion value for estimating said in vivo diffusion value of said xenobiotic through said mammalian tissue.

4. The method as claimed in claim 3, further comprising estimating a correlation value between in vitro and in vivo diffusion of said xenobiotic through said membrane, wherein said using said estimated in vitro diffusion value for estimating said in vivo diffusion value is carried out by extrapolating said estimated in vitro diffusion value using said correlation value.

5. The method as claimed in claim 4, wherein said mammalian tissue is selected from the group consisting of a heart, a brain, a liver, kidneys and intestine.

6. The method as claimed in claim 5, wherein said xenobiotic is selected from the group consisting of a drug, a herbal medicine, a chemical organic pollutant, a chemical inorganic pollutant and a cosmetic product.

7. The method as claimed in claim 6, wherein said mammalian consists of any laboratory animal or human.

8. The method as claimed in claim 7, wherein said mammalian-specific data further comprises physiological and anatomical properties of said mammalian related data.

9. The method as claimed in claim 8, wherein said physiological and anatomical properties of said mammalian related data are selected from the group consisting of volume of tissues, composition of said tissues in lipids, phospholipids and water, volume of blood in equilibrium in said tissues and blood flow to said tissues.

10. The method as claimed in claim 9, wherein said xenobiotic-specific data comprises physiochemical properties of said xenobiotic related data.

11. The method as claimed in claim 10, wherein said physiochemical properties of said xenobiotic related data are selected from the group consisting of molecular weight, lipophilicity and solubility of said xenobiotic.

12. The method as claimed in claim 11, wherein said estimating an in vitro diffusion value of said xenobiotic through a membrane of said mammalian comprises:
determining a permeability value of said xenobiotic through said membrane from apical to basolateral side;
determining a permeability value of said xenobiotic through said membrane from basolateral to apical side; and
estimating said in vitro diffusion value using said determined permeability values.

13. The method as claimed in claim 12, wherein said estimating an in vitro diffusion value is carried out by using a mathematical equation comprising as parameters said measured permeability values.

14. The method as claimed in claim 13, wherein said at least one of an in vitro estimated efflux value and an in vitro estimated influx value of said xenobiotic through said mammalian tissue is obtained by:
determining a permeability value of said xenobiotic through said membrane from apical to basolateral side;
determining a permeability value of said xenobiotic through said membrane from basolateral to apical side; and
estimating said at least one of an in vitro efflux value and an in vitro influx value using said determined permeability values.

15. The method as claimed in claim 14, wherein said estimating said at least one of an in vitro efflux value and in vitro influx value is carried out by using a mathematical equation comprising as parameters said measured permeability values.

16. The method as claimed in claim 15, wherein said estimating a correlation value between in vitro and in vivo diffusion of said xenobiotic through said membrane comprises:
estimating a correlation value between in vitro and in vivo diffusion of various transporters substrates;
estimating said correlation value between in vitro and in vivo diffusion of said xenobiotic through said membrane using said estimated correlation value between in vitro and in vivo diffusion of various transporters substrates.

17. The method as claimed in claim 16, wherein said estimations of said correlation values are carried out by using mathematical equations.

18. The method as claimed in claim 17, wherein said simulated pharmacokinetic profile of said xenobiotic disposition comprises a predicted distribution profile of said xenobiotic in said mammalian tissue.

19. The method as claimed in claim 17, wherein said simulated pharmacokinetic profile of said xenobiotic disposition comprises a predicted amount and rate of absorption of said xenobiotic in said mammalian tissue.

20. The method as claimed in claim 17, wherein said simulated pharmacokinetic profile of said xenobiotic disposition comprises a predicted concentration-time profile of said xenobiotic in said mammalian tissue.

21. The method as claimed in claim 17, wherein said simulated pharmacokinetic profile of said xenobiotic disposition comprises an eliminated amount of said xenobiotic by hepatic metabolism and by renal or fecal excretion.

22. A software code including embedded information embedded therein by the method according to claim 1.
